(19) United States
(12) Patent Application Publication
(10) Pub. No.: US 2008/0178513 A1
(43) Pub. Date: Jul. 31, 2008

(54) Fish Retrieval Apparatus and Method

(76) Inventor: Blake Kennedy, Blanco, TX (US)

Correspondence Address: HAYNES AND BOONE, LLP, 901 Main Street, Suite 3100, Dallas, TX, 75202, US

(21) Appl. No.: 11/669,459

(22) Filed: Jan. 31, 2007

(51) Int. Cl. A01K 97/14; A01K 97/00

(52) U.S. Cl. 43/5; 43/4; 43/17.2

(57) ABSTRACT

A method for retrieving a fish that has been caught on a fishing line according to which a rope is secured to a loop, the line is secured to the loop, and the rope is pulled to retrieve the line.

### BACKGROUND

The present invention relates to an apparatus and method for retrieving a fish after it has been caught by a fisherman.

The most popular type of fishing gear is a rod and reel which is used by fishermen on land, docks, piers, and boat decks. A line is wound on the reel and a lure, or a hook with bait attached thereto, is tied to one end of the line. The hook is cast into the water so that the bait or lure will attract the fish. When a fish is caught, the fisherman can reel the fish in using the reel and when the fish is close enough, he or she can use a net, gaft or the like, for retrieval. However, when a relatively large, “big-game” fish is caught, it is often very difficult to retrieve the fish in this manner due to its size and strength.

An embodiment of the present invention is directed to a retrival apparatus and method according to which the fish can be retrieved from the water easily and quickly without using a net or gaft.

### BRIEF DESCRIPTION OF THE DRAWINGS

FIG. 1 is an elevational view of the apparatus of the present invention.

FIG. 2 is a view similar to that of FIG. 1 but showing a component of the apparatus in an open position.

FIG. 3 depicts a fishermen utilizing the apparatus of the present invention.

FIG. 4 depicts an alternate embodiment of the fishing line.

### DETAILED DESCRIPTION

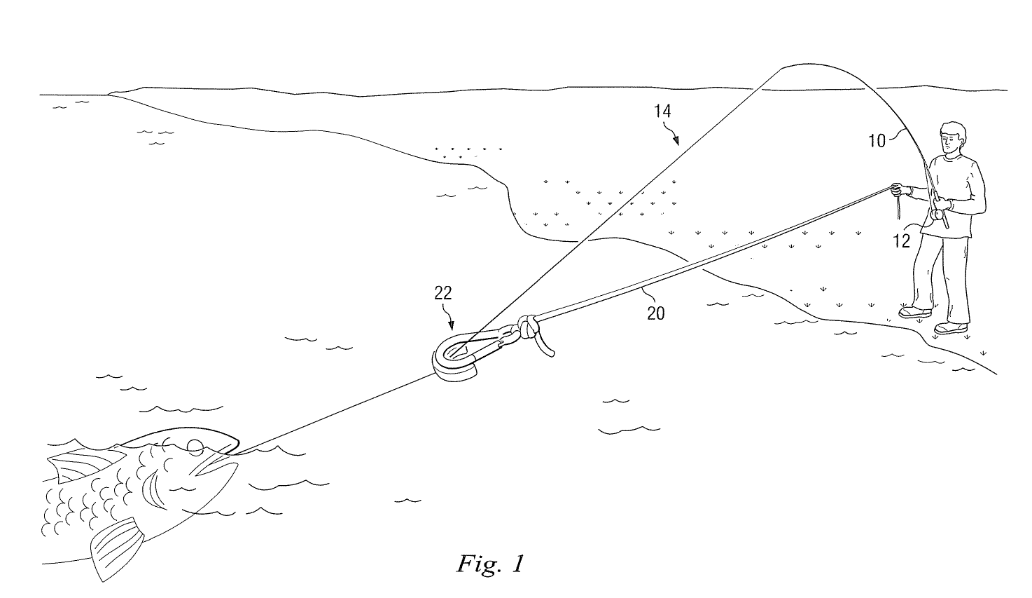

FIG. 1 depicts a fisherman utilizing a rod 10 having a reel 12 attached thereto. A fishing line, shown generally by the reference numeral 14 and described in detail later, has a portion wound on the reel 12 and a portion of the line extending from the rod and into the water. Although not shown in FIG. 1, a hook, or a fishing lure including a hook, is attached to the free end of the line 14, and it will be assumed that a relatively large fish has been caught on the hook.

The fisherman is also grasping one end portion of a rope 20 having an oblong metal loop 22 attached at one end thereof. The loop 22 extends over the fishing line 14, and it is used with the rope 20 to retrieve the fish in a manner to be described.

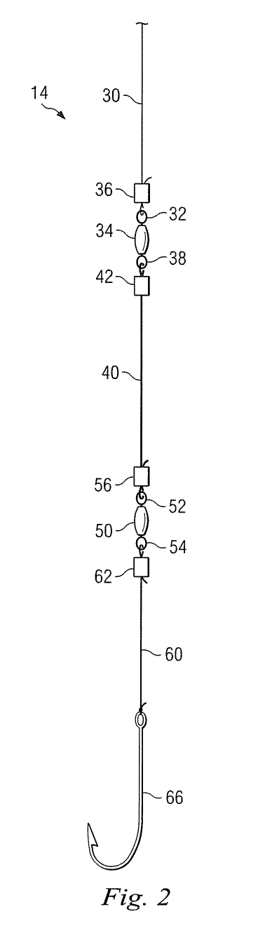

As better shown in FIG. 2, the line 14 consists of a regular fishing line 30 that has a portion wound on the reel 12. The line 30 extends though one or more openings or rings (not shown) provided on the rod 10 (FIG. 1), and another portion of the line extends from the rod 10. The free end portion of the line 30 is looped around a ring 32 provided at one end of a swivel 34. The free end portion of the line 14 is then doubled back, and a crimp sleeve 36 is crimped over the doubled back line portion and the corresponding portion of the line 30 so as to secure the line 24 to the swivel 34.

Another ring 38 is provided at the other end of the swivel 34 and one end portion of a leader line 40 is looped through the ring and doubled back. A crimp sleeve 42 is crimped over the doubled back portion and the corresponding portion of the leader line 40 so as to secure the leader line to the swivel 34. The swivel 34 is conventional and, as such, allows for relative angular movement between the rings 32 and 38.

Another swivel 50 is provided that can be identical to the swivel 34 and, as such, has two rings 52 and 54 extending from its respective ends. The other end portion of the leader line 40 is looped through the ring 52 and doubled back. A crimp sleeve 56 is crimped over the doubled back portion and the corresponding portion of the leader line 40 so as to secure the leader line to the swivel 50.

One end portion of the hook line 60 is looped through the ring 54 and doubled back. A crimp sleeve 62 is crimped over the doubled back portion and the corresponding portion of the hook line 60 so as to secure the hook line to the swivel 50. A hook 66 is tied to the other end of the hook line 60.

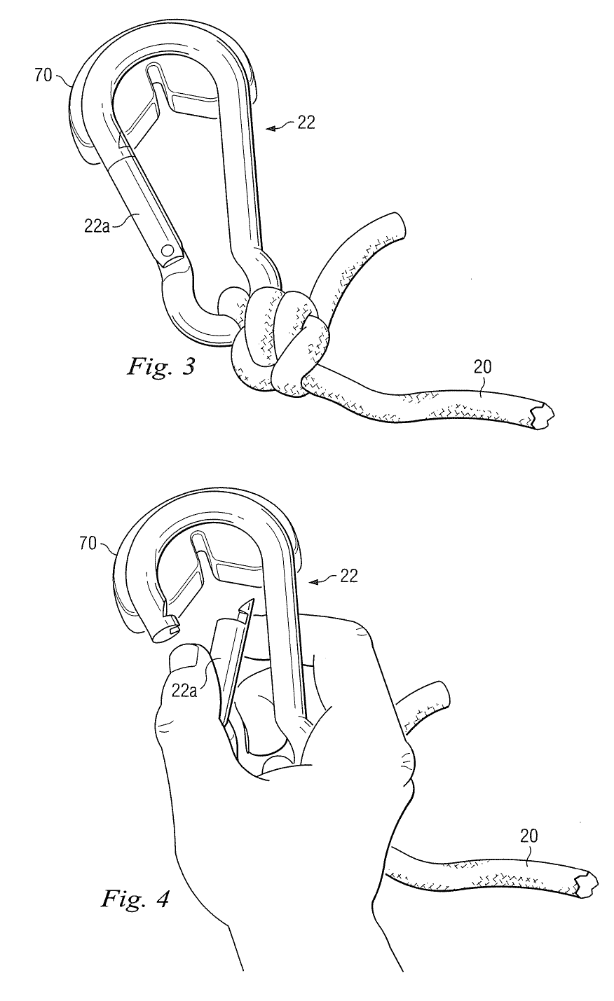

Referring to FIG. 3, the loop 22 has a spring-loaded gate, or leg 22a, that pivots in a manner to be described. This type of device is often generally referred to as a “carabiner” although the present invention is not limited to such a device.

A metal plate 70 is secured, in any known manner, such as by welding, to the other end portion of the loop 22. A slot, or notch 70a, is provided in the center of the plate 70. It is understood that the width of the notch 70a is sized to be slightly less than the width of the crimped sleeves 42 so that the crimped sleeve will be retrained by the notch under certain conditions to be described.

FIG. 4 depicts the leg 22a after it has been manually pivoted inwardly to create a gap for enabling the line 30 (FIG. 2) to be inserted into the loop 22. After the leg 22a is released, it will move back to the position of FIG. 3 under the aforementioned spring load.

Although the fisherman can manually reel the fish in, it is often extremely difficult to retrieve the fish from the line especially when the fish is relatively large. In this case, after the fish has been secured on the hook 66 and the fishing line 14 thus becomes taut, the leg 22a of the loop 22 is manually opened to the position of FIG. 4 and the line is passed into the loop after which the leg is allowed to close under the aforementioned spring load.

As the fisherman holds onto the rope 20, the loop 22 can then be allowed to move down, by gravity, on the line 24 in a direction towards the fish. When the loop 22 has reached the leader line 40 and is thus below the crimped sleeve 42, the fisherman pulls upwardly, on the rope 20. A portion of the leader line 40 below the crimp thus passes through the notch 70a in the plate 70 until the plate reaches the crimped sleeve 42. Thus, further movement of the loop 22 causes corresponding movement of the crimped sleeve 42, the hook line 60, the hook 66, and the fish. Then, the fishermen can continue to pull on the rope 20 to retrieve the fish to the ground, dock, pier, or boat deck. It is understood that during this operation, the fisherman can pull on the rope 20 with one hand while holding the rod 10 in the other hand, or the rod can be discarded and the rope pulled in with both hands.

Thus, the apparatus and method disclosed above enables a relatively large fish to be easily and quickly retrieved once it has been caught, without using a net or gaft.

### Variations

(1) Instead of a loop, one of several other devices can be used, such as, for example, a ring, a buckle or a carabiner.
(2) The leader line 40 can be eliminated and the hook line 60 can be connected to the line 30 using a crimped sleeve, as discussed above.
(3) The hook line 60 can be eliminated and the hook 66 can be connected to the end of the leader line 40.
(4) The loop 22 could be positioned on the line 14 below the crimped sleeve 62 which would be the same size as the crimped sleeve 42 and thus would function in the same manner.
(5) The fishing line 30 can be inserted in the loop 22 in manners other than the one described above.
(6) The plate 70 can be formed integrally with the loop.
(7) The width of the notch 70a can be varied to accommodate different sizes of crimped sleeves, depending on the size of the fish.
(8) The notch 70 can be eliminated and a notch can be formed directly in the loop 22, or in a member, other than the plate, can be attached to, or formed integrally with, the loop.
(9) The swivels 34 and/or 50 can be eliminated and the leader line 40 can be connected to the fishing line 30 and/or to the hook line 60 by connecting the respective lines to interlocking rings, or the like.

Those skilled in the art will readily appreciate that many other variations and modifications are possible in the exemplary embodiment disclosed above without materially departing from the novel teachings and advantages of this invention. Accordingly, all such variations and modifications are intended to be included within the scope of this invention as defined in the following claims. In the claims, means-plus-function clauses are intended to cover the structures described herein as performing the recited function and not only structural equivalents, but also equivalent structures.

What is claimed is:

1. An apparatus for assisting in the retrieval of a fish that has been caught on a fishing line, the apparatus comprising a rope; a loop secured to one end of the rope of and adapted to allow a fishing line to be inserted into the loop; and means associated with the loop to secure the line.

2. The apparatus of claim 1 wherein the loop comprises a pivotal leg that can be opened to allow the fishing line to be inserted in the loop.

3. The apparatus of claim 1 wherein the means comprises a notch associated with the loop.

4. The apparatus of claim 3 wherein the line is secured in the notch upon the rope being pulled towards the fisherman.

5. The apparatus of claim 4 wherein the line is wedged in the notch.

6. The apparatus of claim 1 wherein the means comprises a plate secured to the loop and a notch formed in the plate for receiving the line.

7. The apparatus of claim 6 wherein the line is secured in the notch upon the rope being pulled towards the fisherman.

8. The apparatus of claim 7 wherein the line wedges in the notch.

9. A method for retrieving a fish that has been caught on a fishing line, the method comprising attaching a rope to a loop, securing the line to the loop, and pulling on the rope to retrieve the line.

10. The method of claim 9 wherein the step of securing comprises inserting the line in the loop and pulling on the rope to secure the line in a notch associated with the loop.

11. The method of claim 10 wherein the line is wedged in the notch.

12. The method of claim 10 wherein the notch is formed in a plate attached to the loop.

13. The method of claim 10 wherein the line is secured in the notch upon the rope being pulled towards the fisherman.

14. The method of claim 13 wherein the line is wedged in the notch.
